(19) United States
(12) Patent Application Publication
(10) Pub. No.: US 2024/0009885 A1
(43) Pub. Date: Jan. 11, 2024

(54) Circular Saw

(71) Applicant: Bosch Power Tools (China) Co. Ltd., Zhejiang (CN)

(72) Inventors: Aigui Wang, Zhejiang (CN); Jizhong Fu, Zhejiang (CN)

(21) Appl. No.: 18/345,225

(22) Filed: Jun. 30, 2023

(30) Foreign Application Priority Data
Jul. 6, 2022 (CN) 2022 1079 6426.7

(51) Int. Cl. B27G 19/04

(52) U.S. Cl. CPC B27G 19/04

(57) ABSTRACT

A circular saw includes (i) a circular saw blade that is pivotally connected to a rotary shaft and driven to rotate by way of the rotary shaft, (ii) a tool body that supports the rotary shaft and has a fixed guard covering an upper portion of the circular saw blade, (iii) a movable guard pivotally connected to the rotary shaft and closing in a normal state a cutting region of the circular saw blade, and (iv) an elastic connecting member, including a first point connected to the tool body and a second point connected to the movable guard. The movable guard, under the action of an external force, is capable of opening the cutting region. The elastic connecting member includes a rectilinearly stretching segment connected to the first point and a first torsional connecting segment connected to the second point. The rectilinearly stretching segment has a coil spring, and the first torsional connecting segment is a non-coil spring connecting member. The elastic connecting member is designed to be divided into the rectilinearly stretching segment and the torsional connecting segment, so that the excellent axial stretching performance of the coil spring is utilized, and torsion and friction of the torsional connecting segment are avoided, thereby reducing the design difficulty of the coil spring and improving the service life.

This application claims priority under 35 U.S.C. § 119 to application no. CN 2022 1079 6426.7, filed on Jul. 6, 2022 in China, the disclosure of which is incorporated herein by reference in its entirety.

The present disclosure relates to a circular saw, and in particular, to a circular saw having a guard.

### BACKGROUND

Circular saws are widely applied in fields such as construction engineering. A typical circular saw typically has a circular saw blade driven to rotate, a fixed guard covering an upper portion of the circular saw blade, and a movable guard rotatably covering a lower portion of the circular saw blade. In order to prevent potential injury to nearby personnel caused by exposed teeth of the circular saw blade, the movable guard is typically connected to the fixed guard by means of a coil spring, and covers, in a normal state, the cutting portion of the circular saw blade. If the movable guard abuts a machined material, the movable guard overcomes an acting force of the coil spring to rotate, and the circular saw blade is exposed according to the amount of rotation thereof. If the movable guard no longer abuts the machined material, the movable guard is reset by means of the acting force of the coil spring, and isolates the cutting portion of the circular saw blade again.

However, the advantage of the coil spring is mainly that the axial stretching performance is stable. The coil spring in the above disclosure is also subjected to additional torsion and friction force, etc., in addition to axial stretching, thereby resulting in higher design difficulty and a higher failure rate.

Accordingly, the existing circular saw needs to be improved to overcome the defects in the prior art.

### SUMMARY

The present disclosure is directed to providing an improved circular saw, which can alleviate the problems of high design difficulty of a springback mechanism and unstable service life.

For this reason, according to an aspect of the present disclosure, provided in the present disclosure is a circular saw, comprising: a circular saw blade, pivotally connected to a rotary shaft and driven to rotate by means of the rotary shaft; a tool body, supporting the rotary shaft and having a fixed guard covering an upper portion of the circular saw blade; a movable guard, pivotally connected to the rotary shaft and closing, in a normal state, a cutting region of the circular saw blade; and an elastic connecting member, comprising a first point connected to the tool body and a second point connected to the movable guard, the movable guard, under the action of an external force, being capable of opening the cutting region, the elastic connecting member comprising a rectilinearly stretching segment connected to the first point and a first torsional connecting segment connected to the second point, the rectilinearly stretching segment having a coil spring, and the first torsional connecting segment being a non-coil spring connecting member.

In the present disclosure, the elastic connecting member is designed to be divided into the rectilinearly stretching segment and the torsional connecting segment, so that the excellent axial stretching performance of the coil spring is utilized, and torsion and friction of the torsional connecting segment are avoided, thereby reducing the design difficulty of the coil spring and improving the service life.

### BRIEF DESCRIPTION OF THE DRAWINGS

The above and other aspects of the present disclosure will be understood and appreciated more thoroughly below with reference to specific embodiments and the accompanying drawings.

In the accompanying drawings:

FIG. 1 is a schematic structural diagram of a circular saw in a normal state according to a first embodiment of the present disclosure;

FIG. 2 is a schematic structural diagram of a movable guard in FIG. 1 in a maximum open position;

FIG. 3 is a schematic structural diagram of a circular saw in a normal state according to a second embodiment of the present disclosure;

FIG. 4 is a schematic structural diagram of a circular saw in a normal state according to a third embodiment of the present disclosure; and

FIG. 5 is a schematic structural diagram of a movable guard in FIG. 4 in a maximum open position.

### DETAILED DESCRIPTION

Some feasible embodiments of the present disclosure will be described below with reference to the accompanying drawings. In different accompanying drawings, the same or similar components are denoted by the same reference numerals. In addition, it should be understood that the accompanying drawings are merely for explaining the present disclosure, and the sizes and proportional relationships of components and the number of components in the accompanying drawings are not limitations on the present disclosure. In addition, in order to clearly describe the specific embodiments, “in the normal state” will be added before some structural relationships in the relevant content, so as to indicate that the state is the initial state in which the movable guard is not pressed by any workpiece and the elastic connecting member does not stretch or deform due to an operational external force.

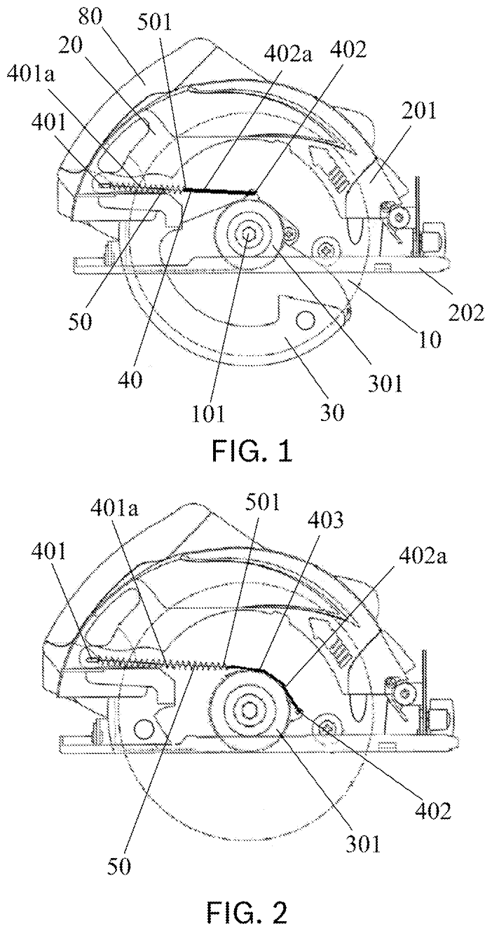

Referring to a first embodiment shown in FIG. 1 and FIG. 2, a circular saw of the present disclosure includes a circular saw blade 10, pivotally connected to a rotary shaft 101 and driven to rotate by means of the rotary shaft 101, a tool body 20, supporting the rotary shaft 101 and having a fixed guard 201 covering an upper portion of the circular saw blade 10, a movable guard 30, pivotally connected to the rotary shaft 101 and closing, in a normal state, a cutting region of the circular saw blade 10, and an elastic connecting member 40, including a first point 401 connected to the tool body 20 (connected to the fixed guard 201 in the present embodiment) and a second point 402 connected to the movable guard 30. The movable guard 30, under the action of an external force, is capable of opening the cutting region. The elastic connecting member 40 includes a rectilinearly stretching segment 401a connected to the first point 401 and a first torsional connecting segment 402a connected to the second point 402. The rectilinearly stretching segment 401a has a coil spring 50. The first torsional connecting segment 402a is a non-coil spring connecting member. In the present disclosure, the elastic connecting member is designed to be divided into the rectilinearly stretching segment and the torsional connecting segment, so that the excellent axial stretching performance of the coil spring is utilized, and torsion and friction of the torsional connecting segment are avoided, thereby reducing the design difficulty of the coil spring and improving the service life.

The tool body 20 includes a bottom plate 202. The bottom plate 202 has an open hole (not shown) in which the circular saw blade 10 is penetratingly arranged. The fixed guard 201 and the rotary shaft 101 are located above the bottom plate 202. The movable guard 30 is located below the bottom plate 202. When cutting a workpiece (not shown), a user holds an upper left handle in the hand, and places the bottom plate 202 on an upper surface of the workpiece. The lower right exposed circular saw blade 10 moves rightwards to cut the workpiece, and meanwhile the workpiece presses the movable guard 30 and gradually opens same.

With continued reference to FIG. 1, the movable guard 30 has a support portion 301 supporting the elastic connecting member 40, and the elastic connecting member 40 abuts the support portion 301, and forms the first torsional connecting segment 402a as the movable guard rotates. The support portion 301 supports the elastic connecting member 40 by means of an outer circular end surface that is concentric with the rotary shaft 101.

In the normal state, the support portion 301 has a third point 403 forming the rectilinearly stretching segment 401a together with the first point 401 (in the present embodiment, when the support portion 301 is an outer circular end surface, the rectilinearly stretching segment 401a is a tangent line of the support portion 301, and the third point 403 is a tangent point). The non-coil spring connecting member is a flexible cord 60. The coil spring 50 has a connection point 501 that is connected to the flexible cord 60 and is located, in the normal state, between the first point 401 and the third point 403. It is not necessarily required that the flexible cord 60 is elastically stretchable, and instead it is mainly required that the flexible cord 60 has basic bending and wear resistance performance. For example, the flexible cord 60 may be a steel wire cord or a flexible wear-resistant rubber cord.

Referring to FIG. 2, when the movable guard 30 is in a maximum open position, the coil spring 50 is still not stretched to the first torsional connecting segment 402a. That is, the connection point 501 is located between the first point 401 and the third point 403. Certainly, in some other embodiments, slight interference is allowed. For example, the ratio of the length of the coil spring contained in the first torsional connecting segment 402a to the length of the coil spring contained in the rectilinearly stretching segment 401a is not greater than 1:10, where a dividing position between the rectilinearly stretching segment 401a and the first torsional connecting segment 402a is the third point 403.

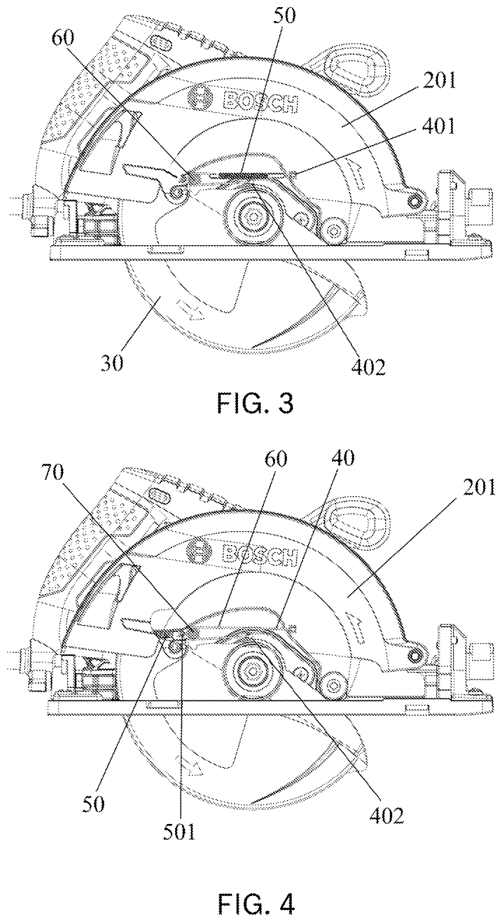

Referring to a second embodiment shown in FIG. 3, the embodiment mainly differs from the first embodiment in that the tool body 20 has a fixed pulley 60. The elastic connecting member 40 is connected to the fixed pulley 60 to form a second torsional connecting segment (i.e., a U-shaped region formed around the fixed pulley, not shown). The first and second torsional connecting segments and/or connecting portions thereof are both non-coil spring connecting members. The advantage of the foregoing solution is that a stretching direction of the coil spring 50 is changed by the fixed pulley 60, so that the first point 401 can be configured freely on the tool body 20, thereby achieving a required stretch length or stretch space.

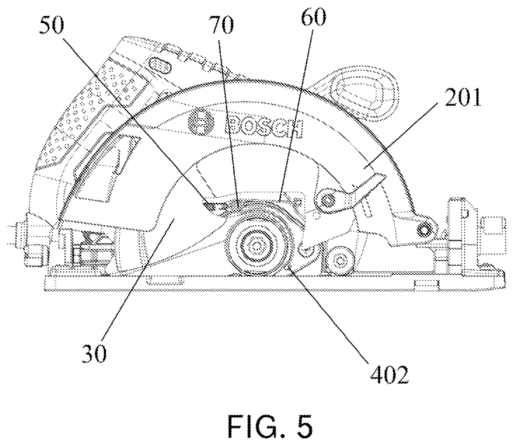

Referring to a third embodiment shown in FIG. 4 and FIG. 5, the foregoing embodiment is mainly implemented by means of a movable pulley. The elastic connecting member 40 includes a movable pulley 70. A rotary shaft of the movable pulley 70 is fixedly connected to the connection point 501 of the coil spring 50. The flexible cord 60 is connected to the movable pulley 70. One end of the flexible cord 60 is fastened to the second point 402, and the other end is fastened to the fixed guard 201. The foregoing design has the following benefits: all of the stretch of the elastic connecting member 40 is no longer completely dependent on the coil spring 50 for completion, and the flexible cord 60, when the movable guard 30 rotates, also participates in adjustment of the total length of the elastic connecting member 40 by means of the movable pulley 70, thereby optimizing distribution of overall load on the elastic connecting member 40.

The above specific embodiments are only for explaining the present disclosure, and are not limitations on the present disclosure. Those of ordinary skill in the art could further make various changes and variations without departing from the scope of protection of the present disclosure. Therefore, all equivalent technical solutions also fall within the scope of the present disclosure, and the scope of protection of the present disclosure is defined by the claims.

What is claimed is:

1. A circular saw, comprising:
a circular saw blade pivotally connected to a rotary shaft and configured to be driven to rotate by way of the rotary shaft;
a tool body, supporting the rotary shaft, and having a fixed guard configured to cover an upper portion of the circular saw blade;
a movable guard pivotally connected to the rotary shaft and closing, in a normal state, a cutting region of the circular saw blade; and
an elastic connecting member having a first point connected to the tool body and a second point connected to the movable guard,
wherein the movable guard, under action of an external force, is configured to open the cutting region,
wherein the elastic connecting member includes a rectilinearly stretching segment connected to the first point and a first torsional connecting segment connected to the second point,
wherein the rectilinearly stretching segment includes a coil spring, and
wherein the first torsional connecting segment is a non-coil spring connecting member.

2. The circular saw according to claim 1, wherein:
the tool body has a fixed pulley,
the elastic connecting member is connected to the fixed pulley to form a second torsional connecting segment, and
the first and second torsional connecting segments and/or connecting portions thereof are both non-coil spring connecting members.

3. The circular saw according to claim 1, wherein:
the movable guard has a support portion supporting the elastic connecting member, and
the elastic connecting member abuts the support portion and forms the first torsional connecting segment as the movable guard rotates.

4. The circular saw according to claim 3, wherein:
in the normal state, the support portion has a third point forming the rectilinearly stretching segment together with the first point,
the non-coil spring connecting member is a flexible cord, and
the coil spring has a connection point connected to the flexible cord and located, in the normal state, between the first point and the third point.

5. The circular saw according to claim 4, wherein:
when the movable guard is in a maximum open position, the connection point is located between the first point and the third point.

6. The circular saw according to claim 4, wherein:
the elastic connecting member includes a movable pulley,
a rotary shaft of the movable pulley is fixedly connected to the connection point of the coil spring,
the flexible cord is connected to the movable pulley,
one end of the flexible cord is fastened to the second point, and
the other end of the flexible cord is fastened to the fixed guard.

7. The circular saw according to claim 4, wherein the flexible cord is a multi-strand steel wire cord or a flexible wear-resistant rubber cord.

8. The circular saw according to claim 4, wherein the support portion supports the elastic connecting member by way of an outer circular end surface concentric with the rotary shaft.

9. The circular saw according to claim 1, wherein:
when the movable guard is in a maximum open position, the ratio of the length of the coil spring contained in the first torsional connecting segment to the length of the coil spring contained in the rectilinearly stretching segment is not greater than 1:10.

10. The circular saw according to claim 1, wherein:
the tool body includes a bottom plate,
the bottom plate has an open hole in which the circular saw blade is penetratingly arranged,
the fixed guard and the rotary shaft is located above the bottom plate, and
the movable guard is located below the bottom plate.
